(19) United States
(12) Patent Application Publication
(10) Pub. No.: US 2021/0170599 A1
(43) Pub. Date: Jun. 10, 2021

(54) INFORMATION PROCESSING METHOD, CONTROL METHOD OF ROBOT DEVICE, ROBOT SYSTEM, ARTICLE MANUFACTURING METHOD AND INFORMATION PROCESSING APPARATUS

(71) Applicant: CANON KABUSHIKI KAISHA, Tokyo (JP)

(72) Inventor: Hironobu Sasaki, Kanagawa (JP)

(21) Appl. No.: 17/108,991

(22) Filed: Dec. 1, 2020

(30) Foreign Application Priority Data
Dec. 6, 2019 (JP) 2019-221557

(51) Int. Cl. B25J 9/16; G06N 3/12

(52) U.S. Cl. CPC B25J 9/1671; B25J 9/1605; G06F 3/0484; G06N 3/126; B25J 9/1666

(57) ABSTRACT

An information processing method includes an output step in which a control device outputs a wire model having a length and a fixed position that satisfy a predetermined condition based on an initial value of at least one fixed position where a wire wired outside of a movable unit is fixed, an initial value of the length of the wire, and search conditions including physical constraints imposed on the wire associated with a move of the movable unit.

### FIELD OF THE DISCLOSURE

The present disclosure relates to an information processing method used in supporting design of a length and/or fixed positions of a wire, a control method of a robot device, a robot system, an article manufacturing method and information processing apparatus.

### DESCRIPTION OF THE RELATED ART

Various movable units such as robot devices are used in a production line of industrial products. There is a case where a tool such as a hand and a pneumatic chuck is attached to a hand tip of a robot arm of the robot device. A wire such as a signal cable and an air tube is often wired to transmit a driving medium such as an electrical signal and air to the tool of this sort. While such a wire is wired within a body of the robot arm in some cases, they are often wired outside of the arm.

Members typified by the wire such as the signal cable and the air tube arranged along the robot arm as described above are often referred to as a term “cable” in the present specification. That is, the “cable” is often a concept not always referring to a member transmitting electrical signals such as the signal cable but including a wire used in transmitting or propagating another medium such as the air tube for example in the present specification.

While the cable wired outside of the arm deforms or moves along the motion of the robot arm as described above, obstacles such as various external devices and pillars are often disposed around the robot device in a motion environment of the actual robot device. Then, how to avoid a trouble of the cable or the device caused by interference of the cable with these external devices and the obstacle is a big issue in the technology of this sort.

Hitherto, there is known a simulation method of calculating behaviors of the cable arranged around the robot arm. Japanese Patent Application Laid-open No. 2013-35083 discloses a technology of automatically adjusting a coefficient of a repulsive force used in the simulation such that dynamic behaviors, when a signal cable or a wire collides with a rigid body, coincides with a result of the simulation in the simulation of this sort.

Such simulation technology enables to virtually calculate physical behaviors of the cable associated with the motion of the robot device and can be utilized to confirm whether the cable arranged around the robot device interferes with the surrounding environment in advance for example. This technology enables to check whether the cable is coiled around the robot device, whether the cable interferes with the surrounding environment and a state thereof and to program a robot motion that avoids such interference for example based on the results.

By the way, it is necessary to determine a position of an end point of the cable and a length of the cable while considering changes of a radius of curvature, a load caused by tension and the like in wiring design related to the cable of this sort and to a wiring form thereof. Therefore, the cable wiring design requires many parameters to be considered, intuition and experimental rules, so that its personal dependency is high and is costly.

In general, the cable arranged around the robot device is often designed to have an enough allowance for its length so that the cable can generally accommodate with the motion of the robot having a high degree of freedom. However, if the length of the cable is long, a possibility of the cable coming into contact with the surrounding environment increases. Therefore, it is necessary to widely open a space around the robot, even if space efficiency may be aggravated. There is also a case where such an ill effect occurs that an original wide movable range of the robot device is limited by arranging the cable.

### SUMMARY

According to some embodiments of the present disclosure, an information processing method includes an output step in which a control device outputs a wire model having a length and a fixed position that satisfy a predetermined condition based on an initial value of at least one fixed position where a wire wired outside of a movable unit is fixed, an initial value of the length of the wire, and search conditions including physical constraints imposed on the wire associated with a move of the movable unit.

According to some embodiments of the present disclosure, an information processing apparatus includes a control device that outputs a wire model having a length and a fixed position that satisfy a predetermined condition based on an initial value of at least one fixed position where a wire wired outside of a movable unit is fixed, an initial value of the length of the wire and search conditions including a physical constraint imposed on the wire associated with a motion of the movable unit.

Further features of the present disclosure will become apparent from the following description of exemplary embodiments with reference to the attached drawings.

### BRIEF DESCRIPTION OF THE DRAWINGS

FIG. 1 is a block diagram illustrating an arithmetic unit capable of executing a simulation of a present exemplary embodiment.

FIG. 2 is a block diagram illustrating functions of a wiring design support system.

FIG. 3 is a block diagram illustrating functions of a robot simulation function in FIG. 2.

FIG. 4 illustrates a simulation model of a robot and its surrounding environment.

FIG. 5 illustrates a simulation model of the robot, the surrounding environment and a cable.

FIG. 6 is a flowchart illustrating calculation steps for generating a cable model.

FIG. 7 illustrates one example of an input GUI for generating the cable model.

FIG. 8 illustrates one example of a GUI by which physical parameters corresponding to types of cables can be registered.

FIG. 9 is a flowchart illustrating calculating steps of a cable wiring searching function.

FIG. 10 illustrates one example of an input GUI of the cable wiring searching function.

FIG. 11 illustrates a radius of curvature of a divided cable model.

FIG. 12 illustrates one example of a GUI indicating output results of the cable wiring searching function.

FIG. 13 illustrates an image in which a cable passable area is added to the simulation model.

FIG. 14 illustrates one example of a GUI in which the passable area is taken into consideration in the cable wiring searching function.

FIG. 15 is a flowchart illustrating calculation steps of the cable wiring searching function using a genetic algorism.

FIG. 16 illustrates one example of a screen of a simulation program.

FIG. 17 illustrates one example of states of alternations of generation of the genetic algorism.

FIG. 18 illustrates one example of a GUI for taking a type of a cable into consideration in the cable wiring searching function.

FIG. 19 illustrates one example of a GUI indicating output results in a case where the type of the cable is sought.

FIG. 20 illustrates one example of a GUI indicating a plurality of output results of the cable wiring search.

FIG. 21 illustrates one example of a GUI indicating a case where no effective search result has been obtained by the cable wiring search.

### DESCRIPTION OF THE EMBODIMENTS

Modes for carrying out of the present disclosure will be described below with reference to the attached drawings. Note that configurations described below are examples to the end, and a person skilled in the art would be able to appropriately modify their detailed configurations for example within a scope not departing from a gist of the present disclosure. Still further, numerical values adopted in the present exemplary embodiment are merely illustrations of reference numerical values.

### First Exemplary Embodiment

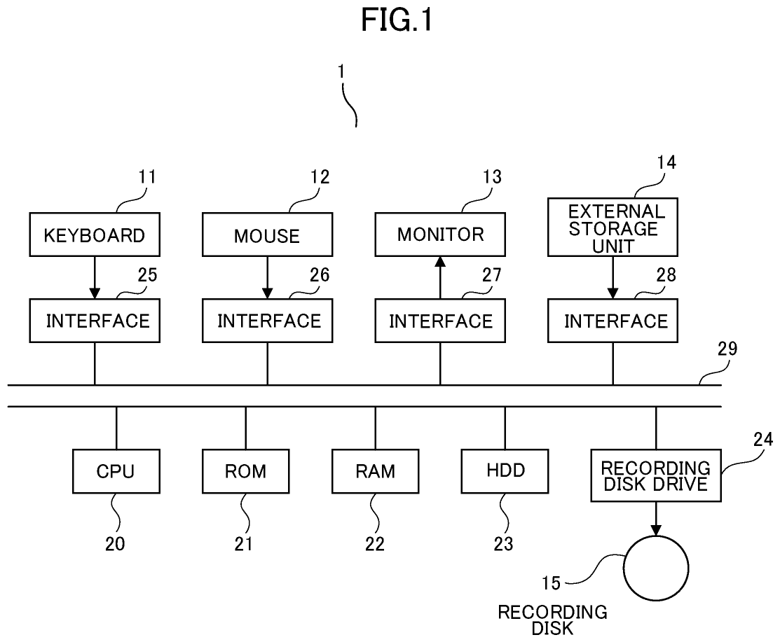

A cable wiring design support system of the present exemplary embodiment will be described below with reference to FIGS. 1 through 12 and FIG. 16.

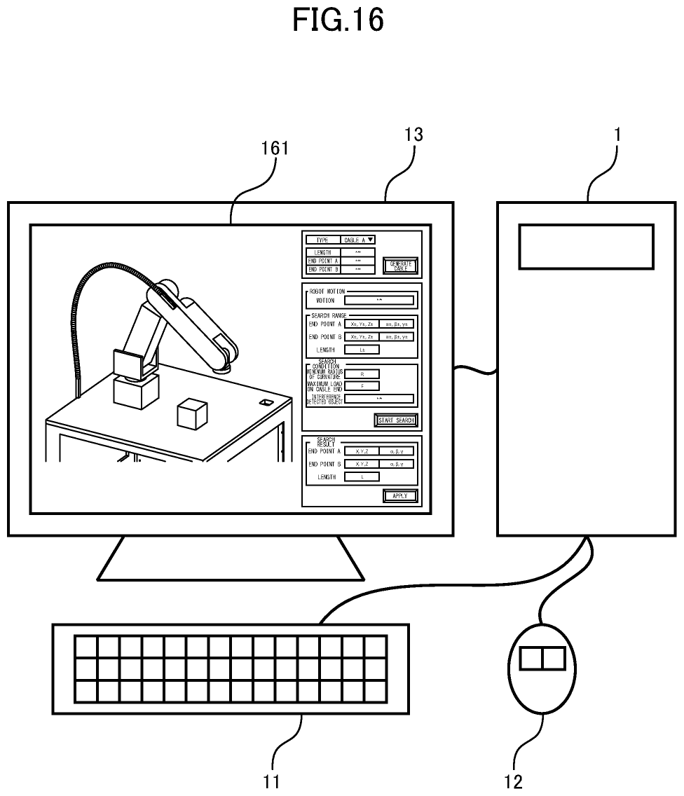

FIG. 1 illustrates an exemplary configuration of a control device 1 capable of executing processes for supporting wiring design of a cable of the present exemplary embodiment. An approximate appearance of the control device 1 takes a form as illustrated in FIG. 16 for example described later. The control device 1 is a processor functioning as a wiring design support system and is composed of a computer system including hardware or the like of a control unit of a PC (personal computer) form for example.

The control device 1 in FIG. 1 comprises a CPU 20 serving as an arithmetic portion, a ROM 21, a RAM 22, a HDD 23, a recording disk drive 24 serving as storage media, and various interfaces 25, 26, 27 and 28. The ROM 21, the RAM 22, the HDD 23, the recording disk drive 24 and the various interfaces 25, 26, 27 and 28 are connected with the CPU 20 through a bus 29 communicably with each other.

A control program for causing the CPU 20 to execute control steps described later is stored in the ROM 21. Then, based on the control program stored in the ROM 21, the CPU 20 executes a control procedure described later. The RAM 22 composes a storage device for temporarily storing process results of the CPU 20. The HDD 23 is an external storage device and stores various information such as parts data, calculation formula of three-dimensional finite element method and others in advance. The HDD 23 stores data such as calculation results of the CPU 20 in accordance with an instruction of the CPU 20.

The control device 1 corresponds to an information processing apparatus as a control main body executing an information processing method for supporting design of a wire of the present exemplary embodiment. The control device 1 is provided with operation input portions including pointing devices such as a keyboard 11 connected through the interface 25 and a mouse 12 connected through the interface 26 to be able to receive various operation inputs. The control device 1 is also provided with a monitor 13 connected through the interface 27 to be able to display various screens such as a data input, i.e., data edit, screen and a display screen for displaying parts and others in a virtual three-dimensional space. A user interface is constructed by using the operation input portions such as the monitor, i.e., the display, 13, the keyboard 11 and the mouse 12. It is possible to realize GUIs (Graphical User Interface) provided with dialogs and menus as described later by this user interface, and the user can make input settings related to conditions for searching intended cable wiring for example.

The interface 28 is configured to be able to connect the external storage device 14 such as rewritable non-volatile memory and an external HDD. A recording disk drive 24 enables to access to the recording disk 15 in reading/writing from/to it. The recording disk 15 can store a program for causing the CPU 20 serving as the control device to execute wiring design support calculation of the present exemplary embodiment. In a case where the recording disk 15 stores the program of the wiring design support calculation of the present exemplary embodiment, the recording disk 15 composes a computer-readable non-temporal storage medium of the present exemplary embodiment. Note that it is also possible to install the program of the wiring design support calculation of the present exemplary embodiment in a rewritable storage area of the external storage device 14, the RAM 22 or the ROM 21 by using the recording disk 15. It is also possible to update an already installed program by using the recording disk 15. However, the installment and update of the program of the wiring design support calculation of the present exemplary embodiment may be performed through a network or the like not illustrated.

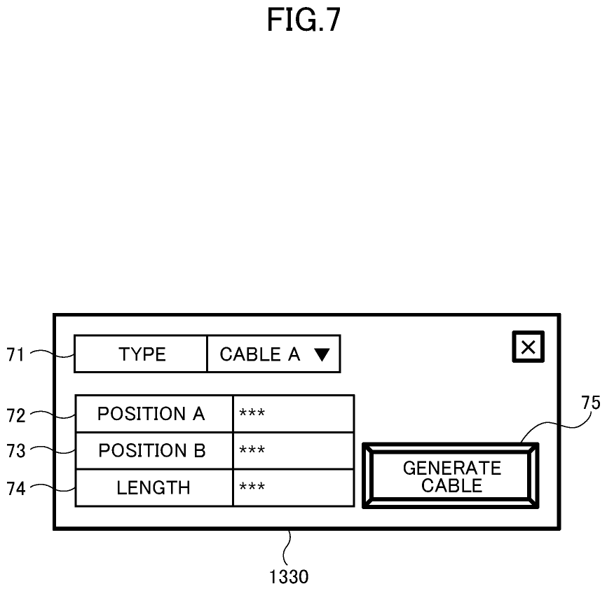

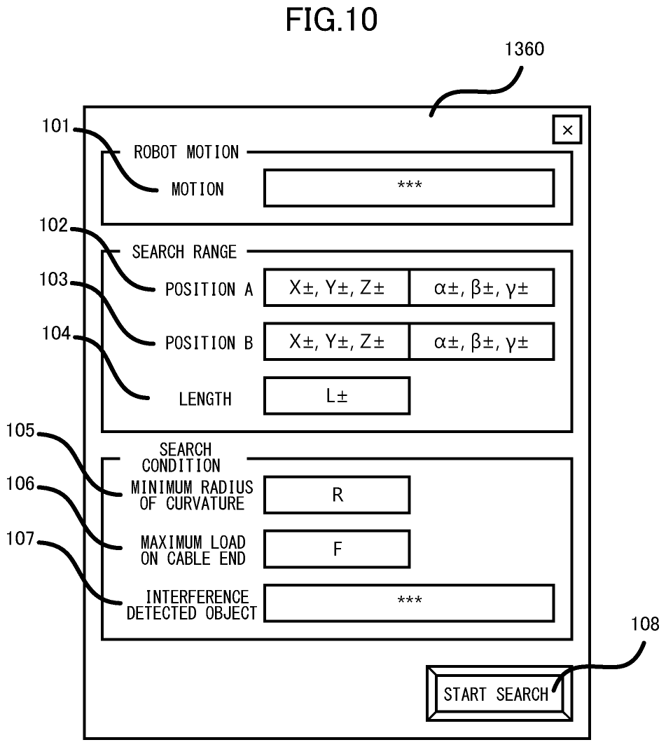

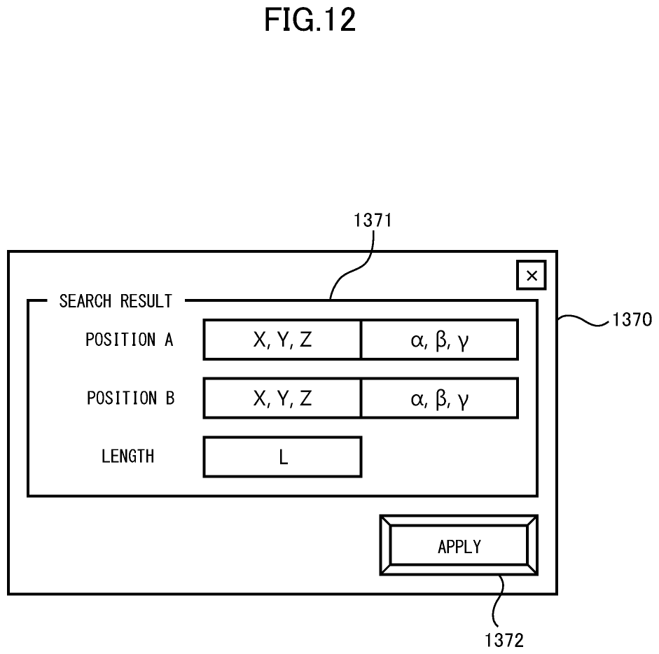

FIG. 16 illustrates one exemplary simulation system provided with the control device 1 described above and the operation input portions such as the monitor 13, the keyboard 11 and the mouse 12 connected to the control device 1. In FIG. 16, a simulation display 161 is displayed on the monitor 13. The simulation display 161 is composed of a display portion of the robot and assembly parts described later and such GUIs as a cable parameter input GUI in FIG. 7, a search parameter input GUI in FIG. 10 and a wiring output GUI in FIG. 12. The simulation display 161 is utilized to simulate and display behaviors of models in a virtual environment corresponding to motions of an actual robot device and its surrounding environment to support the cable wiring design.

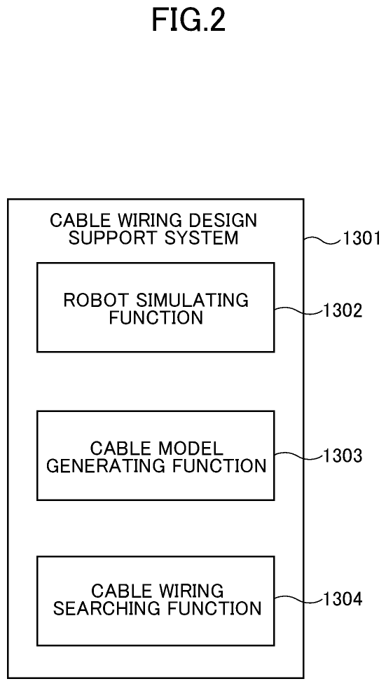

It is desirable to be able to confirm states how the robot device motions in an arbitrary environment to perform the cable wiring design corresponding to the motion of the robot device and its surrounding environment. To that end, the control device 1 of the present exemplary embodiment is constructed as a cable wiring design support system 1301 including functional blocks as illustrated in FIG. 2. The cable wiring design support system 1301 includes a robot simulating function 1302, a cable model generating function 1303 and a cable wiring searching function 1304 as illustrated in FIG. 2.

A cable, i.e., a wire, which is an object of the cable wiring design support system 1301 is disposed outside of the robot device along a body thereof and is deformed or is displaced in association with a motion of the robot device. Accordingly, it is preferable for the cable wiring design support system 1301 to include the robot simulating function 1302 if the cable wiring design support system 1301 is to simulate specifications such as a position of an end point and a length, i.e., a whole length, of the cable, i.e., the wire.

The robot simulating function 1302, the cable model generating function 1303 and the cable wiring searching function 1304 of the cable wiring design support system 1301 will be described below.

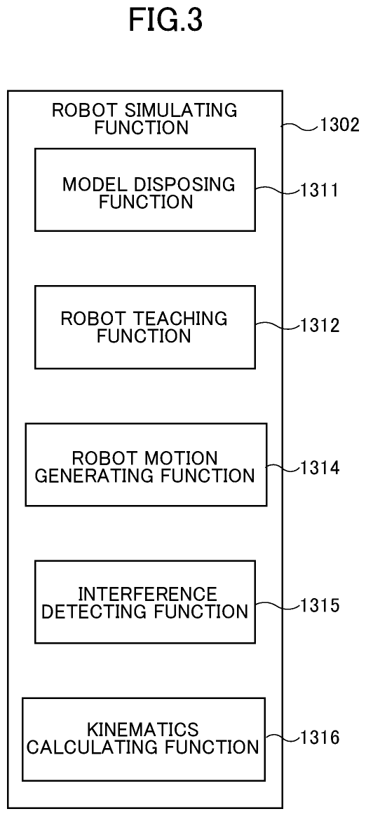

FIG. 3 illustrates functional blocks of the robot simulating function 1302. As illustrated in FIG. 3, the robot simulating function 1302 includes a model disposing function 1311 for disposing a robot model or another device model on a simulator and a robot teaching function 1312 for registering a teaching point which serves as a starting point of the motion of the robot. The robot simulating function 1302 also includes a robot motion generating function 1314 for generating a motion of the actual robot from a move command to the teaching point and an interference detecting function 1315 for detecting an interference with the respective models and informing the user of that. The robot simulating function 1302 also includes a kinematics calculating function 1316 for calculating physical behaviors when the robot device interacts with another object. These functions are functions of a known robot simulator simulating motions of the actual robot device in the virtual environment, so that their detailed description will be omitted here.

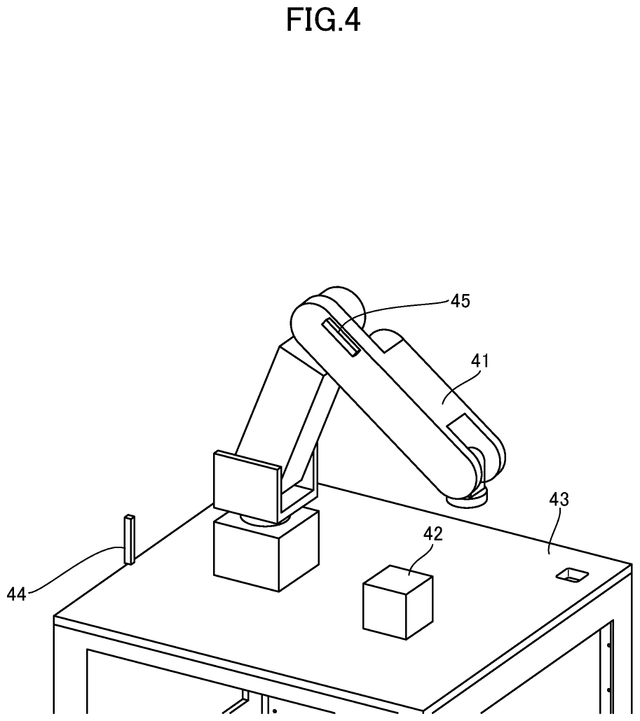

The cable model generating function 1303 in FIG. 2 is a step of generating a cable model used in simulation calculation, i.e., in a first wire model generating step. FIG. 4 illustrates one example of the simulation models of the robot device and its surrounding environment simulated by the robot simulating function 1302. The simulation state in FIG. 4 is a state before a cable model is generated by the cable model generating function 1303. The simulation state in FIG. 4 is composed of models simulating a robot device 41, an object to be worked 42 and a stand 43 as surrounding environments of the robot device. The robot device 41 and a workpiece as the object to be worked 42 are disposed on the stand 43. Note that reference numerals 44 and 45 in FIG. 4 denote fixed positions, i.e., positions A and B described later, of end points where end regions of the cable arranged around the robot device 41 are fixed and connected.

It is noted that the “fixed positions” of the “end points” where the cable, i.e., the wire, is fixed and is connected are for reference only and do not always mean cut end surfaces of both ends of the cable, i.e., the wire, in the present specification. The “end point positions” and “fixed positions” refer to positions where the cable is fixed to a movable device or the surrounding environment by a clip or a connector in specific directions, i.e., a posture expressed by rotation angles α±, β±, γ± described later in a specific three-dimensional coordinate X, Y and Z described later.

The actual robot device 41 manipulates the workpiece serving as the object to be worked 42 with the same motion with a motion simulated by the robot simulating function 1302. This arrangement makes it possible to manufacture articles such as industrial products from the workpieces serving as the object to be worked 42 in a robot system composing a production line in which the robot device 41 is disposed.

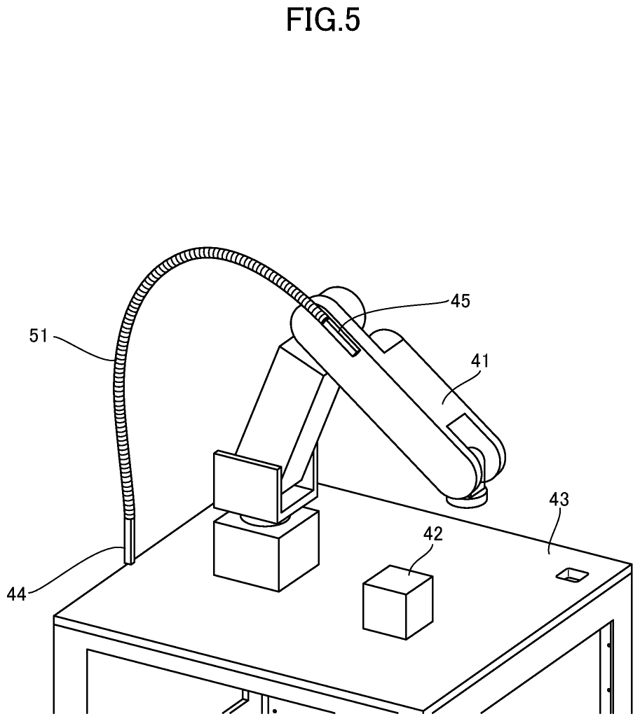

FIG. 5 illustrates one example of a simulation model of the robot device 41 to which a cable 51, i.e., a cable model, generated as the wire by the robot simulating function 1302 is attached and of the surrounding environment. The end points of the both sides of the generated cable 51 are connected at the positions 44 and 45, in addition to the respective component members of the robot device 41 and the surrounding environment denoted by the same reference numerals with those in FIG. 4.

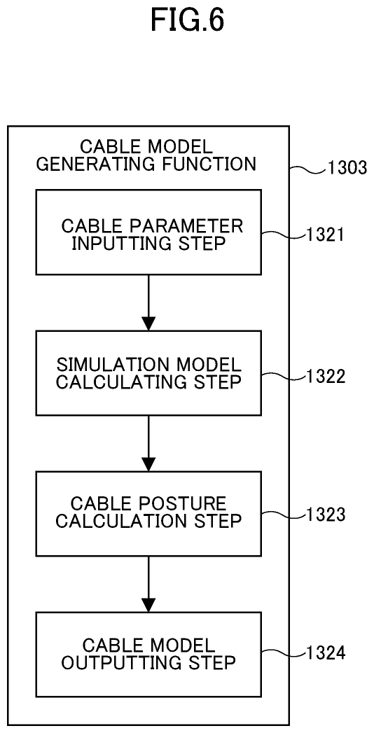

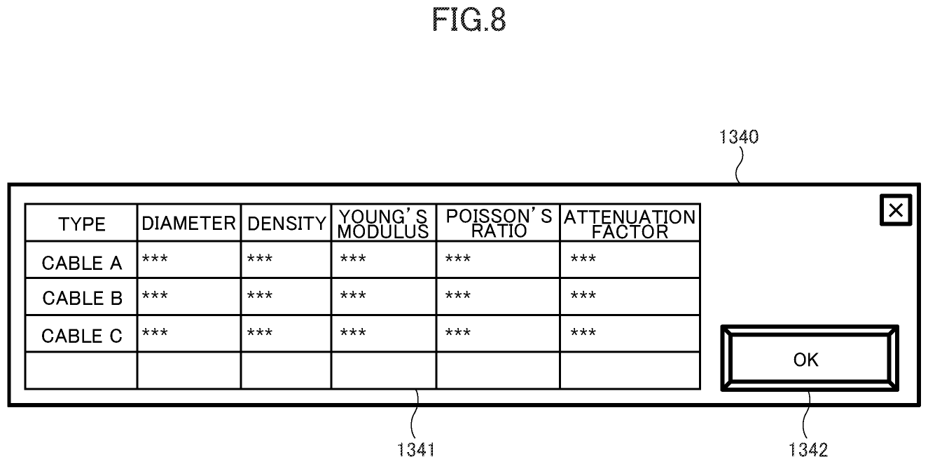

FIG. 6 illustrates a flow of processes of the cable model generating function 1303. In the processes in FIG. 6, firstly the control device 1 accepts user operation of inputting cable parameters by using a GUI 1330 as illustrated in FIG. 7 for example in a cable parameter inputting step, i.e., an initial value setting step, 1321. The GUI 1330 in FIG. 7 is arranged such that a type 71 of cable A, B or C databased in advance as indicated in a GUI 1340 in FIG. 8 can be inputted by a pulldown menu. The GUI 1330 in FIG. 7 includes a cable generating button 75, and when the user operates the cable generating button 75, a cable model having parameters, as initial values, specified in the respective fields of 71 through 74 is generated.

In the GUI 1340 in FIG. 8, the cables A, B and C are databased in advance as species described by several physical parameters. A table display 1341 in the GUI in FIG. 8 can be used in displaying setting contents of physical parameters of the cable models corresponding to the cables A, B and C or in editing set values thereof. In order to simulate dynamic cable behaviors in association with the motion of the robot device 41, the parameters of the cables A, B and C include those related to curve of the cables, i.e., the wires. The parameters related to the curve of the cable, i.e., the wire, include those related to a mass such as a diameter and density and to the curve such as Young's modulus, Poisson's ratio, attenuation factor and others.

The GUI 1330 in FIG. 7 may be arranged so as to be able to clearly input these physical parameters. However, it is possible to readily perform parameter specifying operations of the cable models by operating so as to specify the type 71 indicated in FIG. 7 by preparing the respective physical parameters as the table in advance as indicated in FIG. 8.

In the GUI 1330 in FIG. 7, initial values are specified to determine a cable wiring method how far the cable is to be wired from which position to which position. For instance, two points of end point positions of the cable are set such that a position 72 indicates an end point A and a position 73 indicates an end point B. In this case, it is conceivable to specify them by relative coordinates of the robot device to which the cable is wired. As for the position 44 of the end point A and the position 45 of the end point B of the cable, it is conceivable to register their coordinate positions in the robot model in advance as illustrated in FIG. 4. In such a case, the GUI 1330 in FIG. 7 permits to specify numbers or macro names appropriately allotted to the coordinate positioned registered in advance in the fields of the positions 72 and 73.

Still further, as for the length 74 of the cable, it is preferable to set a length having a sufficient margin such that the cable will not be fully extended even if the robot moves. The positions 72 and 73 as the fixed positions and the length 74 of the cable in the GUI 1330 in FIG. 7 are used as initial values in performing the cable wiring search, so that it is not necessary to input optimum values. Optimum values are generated for the positions 72 and 73 as the fixed positions and the length 74 of the cable corresponding to results of the robot simulation and the like when a cable model is formed by the cable model generating function 1303 of the present exemplary embodiment.

When a cable generating button 75 in the GUI 1330 in FIG. 7 is pressed, the process shifts to the simulation model calculating step 1322 in FIG. 6. A simulation model of the cable is generated in the simulation model calculating step 1322. In the present exemplary embodiment, the cable model, i.e., the wire model, is generated as a simulation model in which a plurality of small cylindrical models is connected. The cable model, i.e., the wire model, is defined by the positions 72 and 73 as the fixed positions and the length 74 of the cable described above.

A length (L) per divisional unit of the cable for example is determined in generating the cable model, i.e., the wire model. While the shorter the length of the divisional unit, the smoother the cable can be simulated, a calculation time increases because the number of divisions increases. As a standard for performing a fully smooth simulation, the divisional unit length (L) can be determined from a diameter (φ) of the cable, as follows:

L=ø Eq.1

Because a shape of the cable division unit is a cylinder having the length (L), information of mass (m), inertia (I) and gravity (g) which are parameters related to the mass can be calculated from a diameter (φ), the divisional unit length (L) and the density (D) as follows. Here, this cylinder is assumed to be extending in a Z-direction of the part coordinate system:

$$\begin{matrix} m = \frac{{∅}^{2} π LD}{12} & \\ g = ( \begin{matrix}{g}_{x} & {g}_{y} & {g}_{z}\end{matrix} ) = ( \begin{matrix}0 & 0 & \frac{L}{2}\end{matrix} ) \\ I = [ \begin{matrix}{I}_{xx} & {I}_{xy} & {I}_{xz} \\ {I}_{yx} & {I}_{yy} & {I}_{yz} \\ {I}_{zx} & {I}_{zy} & {I}_{zz}\end{matrix} ] = [ \begin{matrix}\frac{{∅}^{2} m}{16} + \frac{{L}^{2} m}{12} & 0 & 0 \\ 0 & \frac{{∅}^{2} m}{16} + \frac{{L}^{2} m}{12} & 0 \\ 0 & 0 & \frac{{∅}^{2} m}{8}\end{matrix} ] & Eq . 2\end{matrix}$$

Next, stiffness coefficient (k) and viscosity coefficient (d) per cable division unit are calculated from Young's modulus (E), Poisson's ratio (P), attenuation factor (δ) and others which are parameters related to characteristics of the curve of the cable. These stiffness coefficient (k) and viscosity coefficient (d) can be calculated as follows about the respective directions of x, y and z of the part coordinate system. As a matter of course, values indicated by the table in FIG. 8 in advance corresponding to the type 71 of the cable specified by the GUI in FIG. 7 are used for Young's modulus (E), Poisson's ratio (P), attenuation factor (δ) and others.

$$\begin{matrix} k = ( \begin{matrix}{k}_{x} & {k}_{y} & {k}_{z}\end{matrix} ) = ( \begin{matrix}\frac{E {π∅}^{4}}{64 L} & \frac{E {π∅}^{4}}{64 L} & \frac{E {π∅}^{4}}{64 ( P + 1 )}\end{matrix} ) & \\ d = ( \begin{matrix}{d}_{x} & {d}_{y} & {d}_{z}\end{matrix} ) = ( \begin{matrix}2 {δ}_{x} \sqrt{{I}_{xx} * {k}_{x}} & 2 {δ}_{y} \sqrt{{Y}_{yy} * {k}_{y}} & 2 {δ}_{Z} \sqrt{{I}_{zz} * {k}_{z}}\end{matrix} ) & Eq . 3\end{matrix}$$

A cable model, i.e., a first wire model, in an initial state can be generated by a length specified by the user by connecting the cylindrical models of the cable division unit calculated as described above through a spherical joint and others for example.

In a cable posture calculation step 1323 in FIG. 6, the cable mode generated in the simulation model calculating step 1322 is installed in a simulation environment. At this time, information, i.e., the positions 72 and 73 of the fixed positions of the cable end points set in the GUI 1330 in FIG. 7 are used as initial values of input information.

Here, a root of the cable model of the generated cable model, i.e., the wire model, is installed at the position A where the end point is fixed. While the cable is not deformed and the position B does not coincide with the distal end of the cable in this stage, a variation of the divided cable part can be calculated by performing an inverse kinematics computing such that the distal end of the cable model coincides with the position of the end point B.

Thus, the cable model, i.e., the first wire model, corresponding to the initial state defined by the fixed positions and the length of the initial values by which the end points are fixed, respectively, is generated by the cable posture calculation step 1323. Then, the cable model generated as the first wire model in the initial state in the cable model outputting step 1324 in FIG. 6 can be three-dimensionally displayed on the monitor 13 by a form of wire frames or polygons for example.

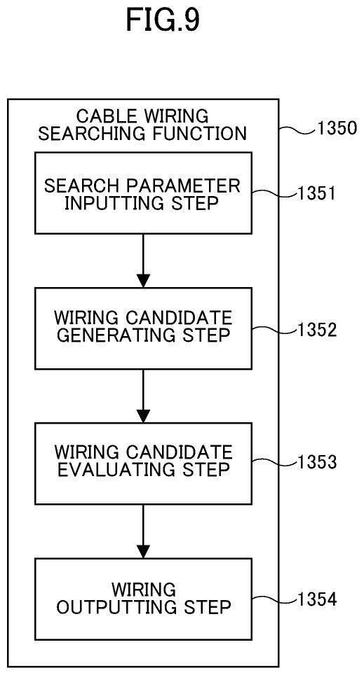

According to the present exemplary embodiment, it is possible to search a wire model, i.e., a cable wiring, having appropriate end point positions and a length by a cable wiring searching function 1350, i.e., the cable wiring searching function 1304 in FIG. 2. FIG. 9 illustrates a schematic flow of the cable wiring searching function 1350. Here, search conditions are specified by a GUI 1360 illustrated in FIG. 10 for setting cable wiring searching functions described later in a search parameter inputting step 1351, i.e., a search condition setting step. Then, a cable model, i.e., a second wire model, having different end point positions and a length is generated as a candidate of the cable wiring by starting from the cable model in the initial state described above in a wiring candidate generating step 1352, i.e., a second wire model generating step. A motion of the device model and a motion of the wire model associated with the motion of the device are simulated in a virtual environment and corresponding to that, an evaluation value for the length and the fixed positions of the wire model are generated in a wiring candidate evaluating step 1353. Still further, a wire model is sought as a wiring candidate corresponding to a wiring form by using the evaluation value to output a length and fixed positions of the wire model having the length and the fixed positions that satisfy an eligible criteria, i.e., a predetermined condition, in a wiring outputting step 1354.

In the cable wiring searching function 1350, it is possible to search and specify the wire model having the appropriate end point fixed positions and the length meeting the eligible criteria by considering results of the robot simulation. Then, it is possible to output the appropriate end point fixed positions and the length meeting the eligible criteria of the wire model.

In the GUI 1360 in FIG. 10 used in the search parameter inputting step 1351, search ranges 102 through 104 of the positions A and B and the length (L±) of the second wire model to be generated as the candidate are specified based on the positions A and B and the length of the first wire model in which the end points are fixed. The search ranges 102 and 103 of the positions A and B are specified by three-dimensional coordinates (X±, Y±, Z±) and rotation angles (α±, β-±, γ±) around coordinate axes and others for example. It is also possible to specify a robot motion 101 to be executed by the robot device in the simulation in the GUI 1360 of the cable wiring searching function 1350 in FIG. 10.

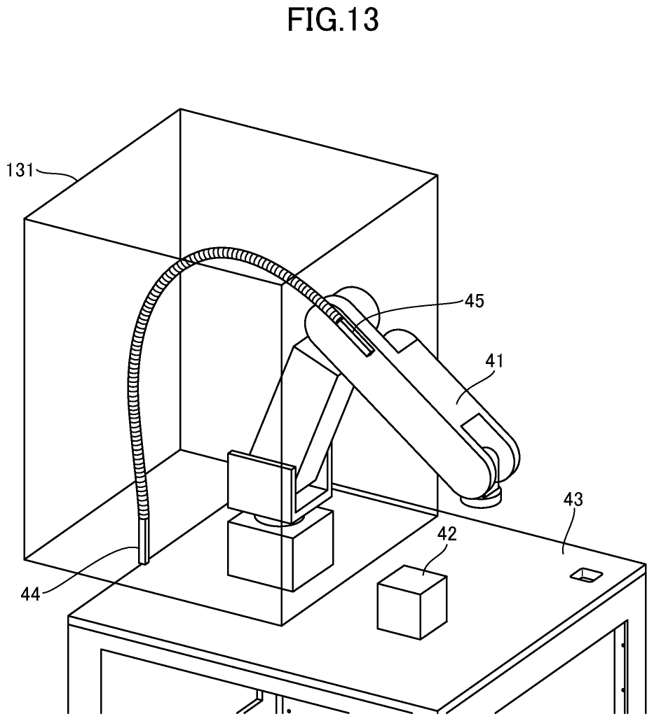

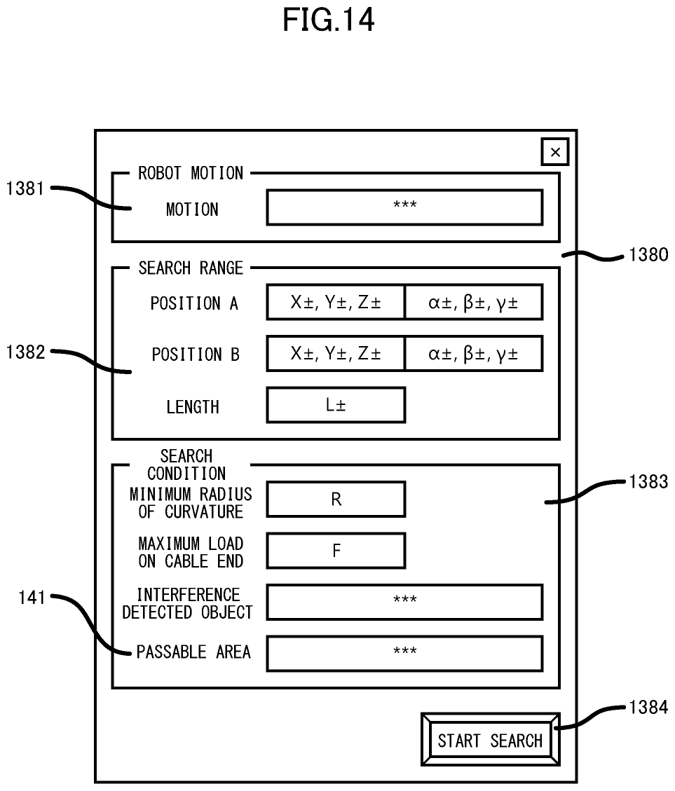

Still further, it is possible to specify physical constraints to be imposed on the cable model in the robot motion as a part of the search conditions in 105, 106 and 107. Included among the search conditions are an allowable cable minimum radius of curvature in 105, a cable end maximum load in 106 and an interference detected object in 107 for example. The interference detected object in 107 can be specified in a form as illustrated in FIGS. 13 and 14 described later. Note that it is possible to execute the specified cable wiring search by operating a search start button 108 after input the robot motion 101, the search ranges 102 through 104 and search conditions 105 through 107 described above in the GUI 1360 in FIG. 10.

In the specification of the robot motion 101 in the GUI 1360 in FIG. 10 of the cable wiring searching function 1350 in FIG. 10, the motion generated by the robot simulator is specified as the robot motion. For instance, a motion already simulated and file outputted in the HDD is specified. Or, it is also possible to adopt an input form that specifies the robot motion 101 by identification information of robot control data in a teaching point format or a robot program format by considering a case where no robot simulation of the device model has been finished.

Still further, in FIG. 10, the positions A and B where the cable end points are fixed are specified by the possible three-dimensional coordinates (X±, Y±, Z±) and rotation angles (α±, β±, γ±) around the coordinate axes in specifying the search ranges 102, 103 and 104. The cable length (L±) is specified in the units of length. Similarly to the case of the cable model generating function 1303, the cable end points can be specified by relative coordinates from parts for which the cable is to be wired, and as for a wiring possible range, the same relative coordinate values can be inputted to the fields 102 and 103. Similarly to the case of the cable model generating function 1303, a range from the initial value of the set cable length can be inputted to the field 104 as for the length of the cable.

Finally, the search conditions are inputted. The physical constraints to be imposed on the cable model such as a setting in 105 of the minimum value of the radius of curvature of the cable, a setting 106 of the maximum value of the load applied to the cable ends and a setting 1 in 07 of the object that should not come into contact with the cable are inputted. After inputting all these parameters, the wiring search can be started by pressing the search start button 108.

In the wiring candidate generating step 1352 in FIG. 9, the cable model, i.e., the first wire model, of the initial state outputted in the cable model generating function 1303 described above is set as a starting point. Then, based on this starting point, the cable model, i.e., the second wire model, is generated as a candidate to be evaluated in the search ranges inputted in the search parameter inputting step. Note that the cable model, i.e., the second wire model, as the candidate from which the evaluation values are generated may include the cable model, i.e., the first wire model, itself or an equivalent model with that. Here, it is possible to generate the cable model, i.e., the second wire model, as at least one wiring candidate by combining the positions A and B and the length contained in the specified search ranges 102 through 104. Note that a multiple number of models may be generated as the cable model, i.e., the second wire model, at a time, or several cable models, i.e., the second wire models, may be generated per generation in a case where a genetic algorism described later is used.

The second wire model to be generated as the evaluation candidate is defined by the parameters of the specific positions A and B and the length included in the specified search ranges 102 through 104 similarly to the first wire model in the initial state. Due to that, the second wire model can be generated by the same routine with the cable model generating function 1303 described above by using the specific positions A and B and the length.

Although a shape of the specific cable mode, i.e., the first or second wire model, may change in association with the motion of the robot device (device model) around which the cable model is disposed, the cable model is defined uniquely by the parameters of the fixed positions, i.e., the positions A and B and the length. Accordingly, such descriptions as “search of candidates of end point positions and length” used below may be considered to be equivalent with “search of a cable model, i.e., a wire model”.

In a wiring candidate evaluating step 1353 in FIG. 9, the second wire model or the first wire model which are the wiring candidate are evaluated respectively. The evaluation value can be calculated by using results of the robot simulation such that one which accumulates a least load to the cable among those satisfying the search conditions for example is evaluated to be highest. The evaluation value of the wiring candidate can be generated with a real number range such as 0 to 10 and 0 to 100 for example.

If the simulation results do not satisfy the search conditions described above, an evaluation value 0 is generated as a lowest evaluation value. Because calculation systems of the detection of interference of the cable with the robot and the surrounding environment and of the load applied to the cable end to be performed in the wiring candidate evaluating step 1353 in FIG. 9 are conventionally known, a detailed description thereof will be omitted here. Or, in a case where the simulation results satisfy the search conditions, it is possible to calculate the evaluation value about the accumulation of the load to the cable for example based on values of variation of the radius of curvature of the cable.

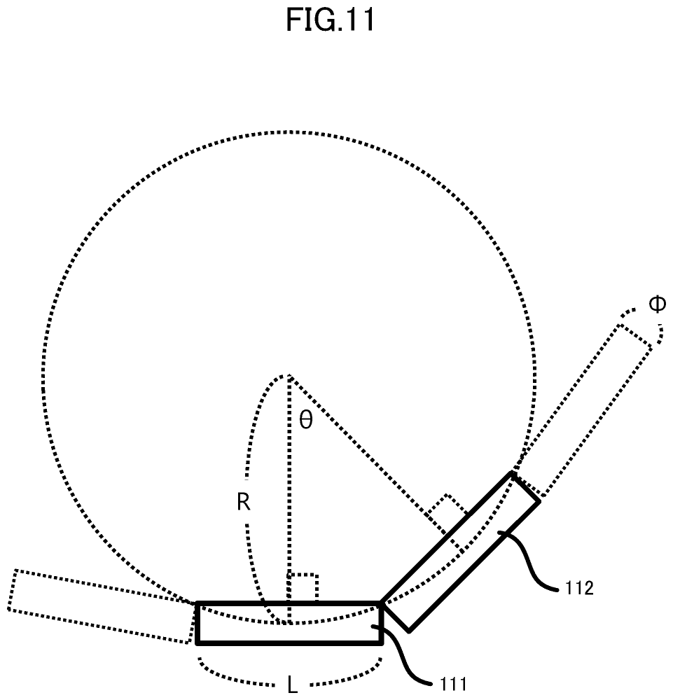

It is possible to calculate the radius of curvature at each division point of the cable model divided into the fine division unit as described above as illustrated in FIG. 11 for example. FIG. 11 illustrates a state in which the cable model divided into division units 111 and 112 is curved. In such a case, it is possible to calculate the radius of curvature (R) made from the division unit 111 to the division unit 112 from a division unit length (L), a cable diameter (φ), and an angle (θ) by which the division unit 112 is angled from the division unit 111, as follows:

$$R = \frac{\frac{L}{2}}{tan ( \frac{θ}{2} )} + \frac{∅}{2} \qquad Eq . 4$$

The radius of curvature (R) of the cable model is changed in association with the simulated robot motion. It is possible to calculate the variation (S) of the radius of curvature (R) from the division unit 111 to the division unit 112, as follow for example:

S=∫ₜ₌₀^{T}|Rₜ₊₁−Rₜ| Eq. 5

The variation (S) of the radius of curvature is calculated between all divided parts composing the cable model. In such a case, a place of a division unit where a maximum value (S_{MAX}) of the variation (S) is calculated may be considered to be a spot where a possibility of being broken or damaged is highest.

Then, because the accumulation of a load to the cable is considered to be proportional to the variation (S) of the radius of curvature, it is possible to calculate the evaluation value (V) of the wiring candidate by using the maximum value (S_{MAX}) of the variation for example, as follows:

$$V = \frac{1}{{s}_{MAX}} \qquad Eq . 6$$

It is possible to generate the evaluation values of the related model or its fixed positions and the length by making the abovementioned calculations on all of the second wire model or the first wire model as the wiring candidates. It is also possible to rank the wiring design of the second wire model or the first wire model as the wiring candidate by using the evaluation values.

Then, a GUI 1370 as illustrated in FIG. 12 is used in the wiring outputting step 1354 in FIG. 9 to output the second wire model or the first wire model which has been evaluated most in the wiring candidate evaluating step. FIG. 12 displays search results 1371 related to the fixed positions, i.e., the positions A and B, and the length (L) to present to the user.

Note that it is possible to arrange such that the search process in the search step is outputted by the three-dimensional simulation display 161 by the user interface composed of the GUI using the monitor 13, the mouse 12 and others. Still further, the robot motion and the motion of the cable model in the virtual environment can be outputted by the simulation display 161 at that time. In such a case, it is possible to present the position and others of the division unit where the maximum value (S_{MAX}) of the variation (S) of the radius of curvature has been calculated as a spot which may be highly possible to be broken by such method of indicating by a mark within the simulation display 161, of changing a display color or of highlight.

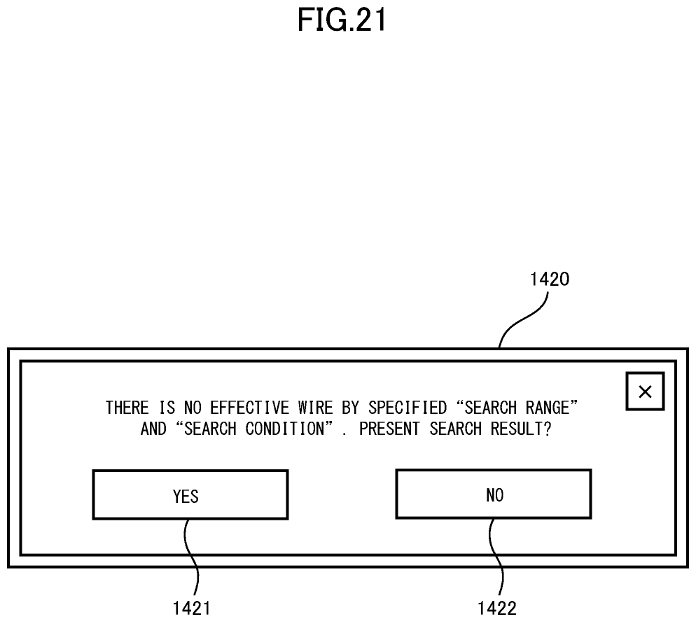

Still further, in a case where all of the sought wiring candidates do not satisfy the search conditions and the evaluation value is zero, a dialog in a GUI 1420 as illustrated in FIG. 21 is presented to the user. “Yes” and “No” buttons 1421 and 1422 urging the user to decide whether the search results are to be presented by the simulation display 161 and others are disposed in the dialog of the GUI 1420. Although no detail is illustrated, it is also possible to display another message urging to change the search range and the search conditions and to dispose dialog buttons of “Yes” and “No” 1421 and 1422. In such a case, the user can effectively correct the search range and the search conditions by presenting the user of a wiring candidate that has satisfied the search conditions for a longest time as for a robot motion for example.

As described above, according to the present exemplary embodiment, it is possible to design an efficient wiring associated with the motion of the robot device serving as the movable unit and the surrounding environment thereof. In such a case, it is possible to output the values related to the length i.e., a whole length, and the fixed positions that satisfy the eligible criteria concerning the cable, i.e., the wire, of a specific type which has less possibility of been broken and which interferes with no surrounding environment.

### Second Exemplary Embodiment

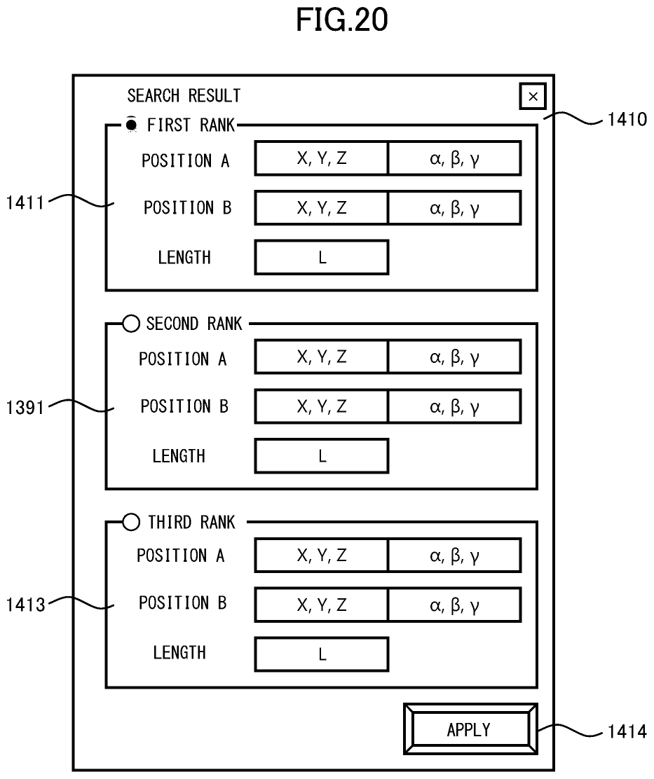

The example of outputting one of the second wire model or the first wire model which has been evaluated most in the wiring candidate evaluating step as illustrated in FIG. 12 has been illustrated in the exemplary embodiment described above. However, it is also possible to arrange so as to output a plurality of second wire models or the first wire models from first to third ranks in accordance a rank of the evaluation values for example as illustrated in a GUI 1410 in FIG. 20. In the GUI 1410 in FIG. 20, parameters 1411, 1391 and 1413 of the fixed positions, i.e., the positions A and B, and the length (L) of the second wire models or the first wire models are outputted respectively in formats similar to that in FIG. 12.

In a wiring design work, there may be a case where it is preferable to compare computation results of the respective parameters of the different fixed positions, i.e., the positions A and B, and the length (L). If such a need is taken into consideration, it is conceivable to be effective to present the user of those whose evaluations have been superior among the wiring search results by the GUI 1410 in FIG. 20.

### Third Exemplary Embodiment

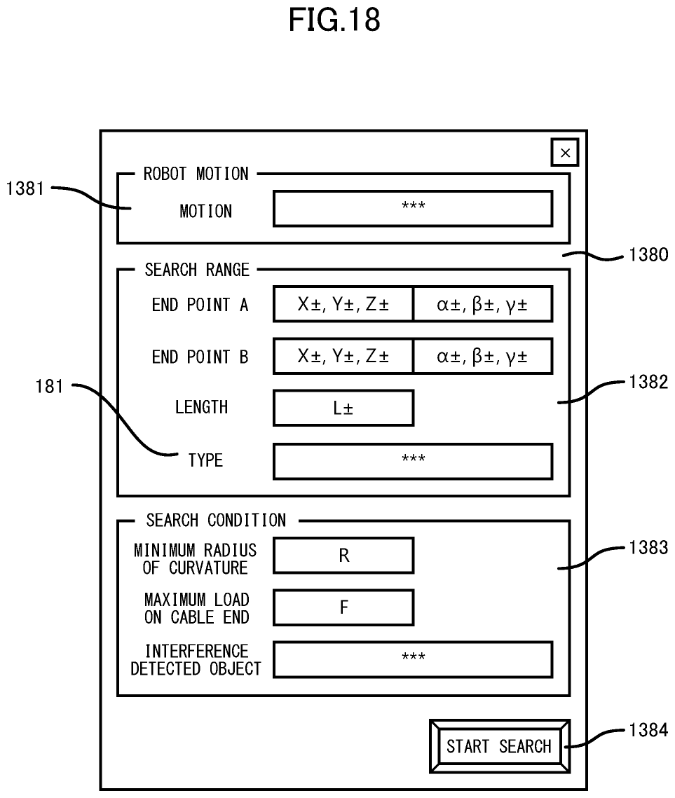

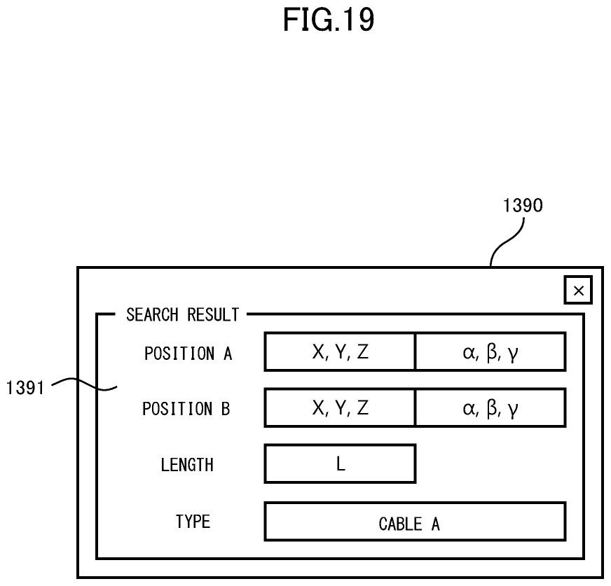

FIGS. 18 and 19 illustrate extended examples of the wiring design support system of the present exemplary embodiment. There is a case where there exist various types of commercially sold cables having different thicknesses and rigidities even if a signal cable has the same or similar electric characteristics for example. Then, there may be a need to select an optimum cable among different types of cables, i.e., wires. In order to accommodate with this need, it is effective to introduce a type of a cable in the search range.

FIG. 18 illustrates one example of a GUI 1380 arranged to be able to specify a type of a cable as a search range in the cable wiring searching function 1350 in FIG. 9. The GUI 1380 in FIG. 18 is what a field 181 for specifying a range of a type of the cable to be sought is added to the GUI 1360 in FIG. 10. The field 181 for specifying the range of the type of the cable is constructed so as to specify identification code or the like of the cable like a cable B and a cable C from the table in FIG. 8 for example in a format such as a CSV format. Or, the field 181 for specifying the range of the type of the cable may be constructed by a pulldown or a pullup menu that permits plural checks.

Next, a wiring candidate, i.e., a second wire model, is generated for the cable model specified by the field 181 in the wiring candidate generating step in FIG. 9. In such a case, the first wire model in the initial state is generated for a plurality of wire models contained in the specified range of the type of the cables described above in the present exemplary embodiment. Then, the search conditions are evaluated in the same manner with the first exemplary embodiment, the wiring candidate, i.e., the second or first wire model, is generated and information related to the length and the fixed positions thereof is outputted.

FIG. 19 illustrates one example of a GUI 1390 indicating wiring search results including the optimum cable in the present exemplary embodiment. In this example, the type of the cable A which has been evaluated most is outputted as illustrated in the lowermost stage of the dialog 1391.

Thus, the present exemplary embodiment enables to select the optimum cable associated with the motion of the movable unit and the surrounding environment among a plurality of types of cables and to perform the wiring design including the cable length and the fixed positions of the cable ends.

### Fourth Exemplary Embodiment

An extended function of the cable wiring design support system will be described by citing FIGS. 13 and 14 in the present exemplary embodiment.

In designing a work environment using the robot device, a layout such as positions of a robot and peripheral units is often determined first and then teaching of the robot is made to determine its motion. It is conceivable that a need of setting a range where the cable passes occurs at the time of layout in a case of using the wiring design support system.

In order to accommodate with this need in the wiring design support system, it is considered to be effective to introduce a cable passable area in the search conditions.

FIG. 13 illustrates a state in which a passable area 131 of the cable is added to the simulation model in the virtual environment. It is possible to arrange such that the user specifies the passable area 131 by setting an area by inputting apex information of a cuboid shape for example by a mouse through the GUI using the monitor 13, the mouse 12 and others for example.

FIG. 14 illustrates one example of a GUI 1380 for specifying the passable area by the cable wiring searching function. The GUI 1380 in FIG. 14 includes dialogs for specifying a robot motion 1381, a search range 1382 and search conditions 1383. Then, the dialog of the specification of the search conditions 1383 in the GUI 1380 in FIG. 14 includes a field 141 for specifying identification information of the passable area 131 specified by the input of the cuboid shape in FIG. 13 for example.

Then, a process for confirming whether the cable does not deviate out of the passable area just needs to be performed in the wiring candidate evaluating step 1353 in FIG. 9 in the present exemplary embodiment. Actually, it is just necessary whether the cable model that moves together with the device model of the movable unit, i.e., the robot device, does not interfere, i.e., intersect, with each plane of the passable area set in the search parameter inputting step. It is possible to confirm whether interference of the plane with the cable model, i.e., the wire model, occurs by the robot simulation function. In a case where the interference of the plane of the passable area with the cable model, i.e., the wire model, is confirmed, the evaluation value of the cable model, i.e., the wire model, is zeroed.

As described above, according to the present exemplary embodiment, it is possible to output the cable model, i.e., the wire model, the length thereof and the fixed positions of the end portions thereof in particular by considering the constraint that the cable does not deviate out of the cable passable area designed in advance. Because no three-dimensional model of the robot surrounding environment needs to be prepared as a secondary effect in the case where the cable passable area is added, the search calculation of the cable wiring can be realized more readily. Note that while the example of setting the cuboid cable passable area has been illustrated in the present exemplary embodiment, it is needless to say that it is possible to calculate the evaluation values by the similar method even if the passable area is cylindrical or is complicated.

### Fifth Exemplary Embodiment

A possibility of speeding up the process for searching the cable model, i.e., the wire model, will be studied in the present exemplary embodiment. For instance, the search ranges of the end point fixed positions, i.e., the positions A and B, and the length (L) specified in the GUIs 1360 and 1380 in FIGS. 10 and 14 have been generated by setting the second wire model as a search candidate in the abovementioned exemplary embodiments. If the search ranges are divided by high search grain size to generate a large amount of second wire models as search candidates at a time, the wiring candidates increase too much and computation costs may increase, though it depends also on the CPU 20 serving as an arithmetic unit. This may require a tremendous processing time, possibly losing practicability of the system.

Then, it is necessary to lower the search grain size to lower the calculation costs in some cases depending on performance of the CPU 20 serving as the arithmetic unit of the wiring design support system. However, if the search grain size is too low, there is a possibility that optimality of the wiring design finally outputted is lowered.

As a technique for solving such an issue, it is conceivable to use a genetic algorism which is one type of meta-heuristic like the present exemplary embodiment.

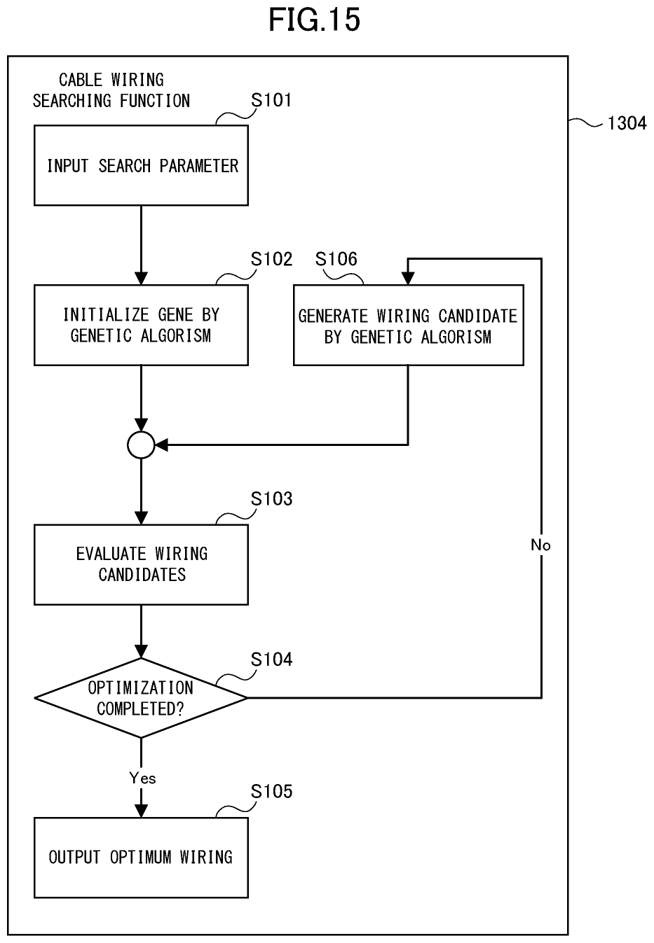

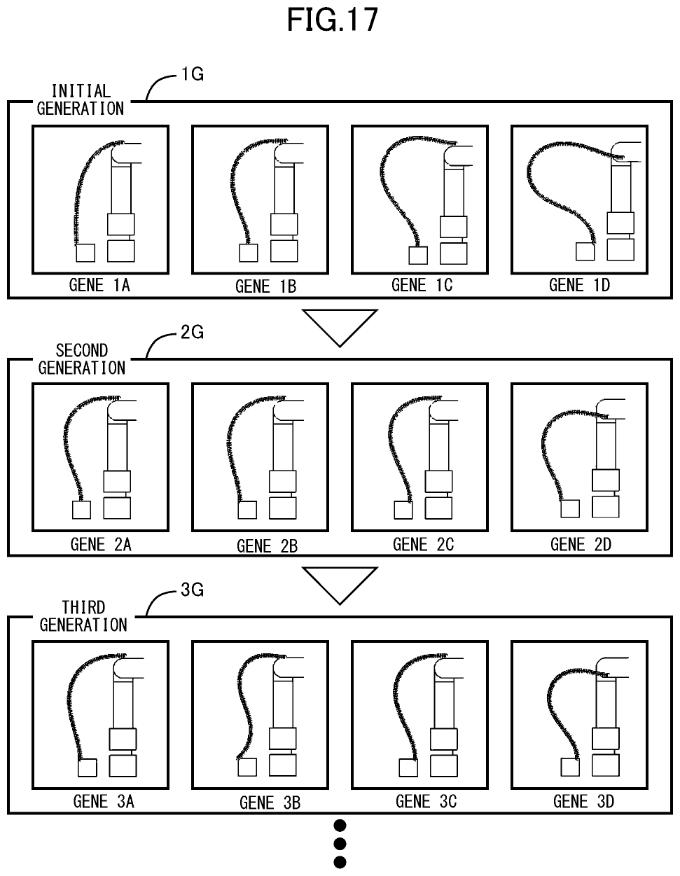

FIG. 15 illustrates a processing procedure for searching wiring of the cable, i.e., the wire, by using the genetic algorism in the present exemplary embodiment. FIG. 17 illustrates states of alternation of generations caused by the genetic algorism. Here, what are used as genetic codes of the genes in the genetic algorism are seven items of two sets of variations (x±, y±, z±) in the search ranges of the fixed positions, i.e., the positions A and B, of the wire and the variation (L±) in the search range of the cable length.

In a search parameter inputting step in Step S101 in FIG. 15, the respective search parameters of the robot motion 101, the search ranges 102 through 104 and the search conditions 105 through 107 are inputted by using a GUI similar to the GUI 1360 in FIG. 10.

Next, finite genes are generated at random within the search ranges in a gene initializing step in Step S102. For instance, genes having various cable end point positions and cable lengths are generated like an initial generation 1G as illustrated in an upper case in FIG. 17. A wiring candidate evaluating step in Step S103 is executed in the same manner with the wiring candidate evaluating step 1353 in FIG. 9 of the first exemplary embodiment. In such a case, evaluation values of the wiring candidates are used also as evaluation values of genes generating the candidates thereof in the computation of the genetic algorism of the present exemplary embodiment.

It is judged whether the optimization is being fully in progress in an optimization completion judging step in Step S104. The optimization completion judging step in Step S104 functions also for determining an escape condition of the searching process. A comparison operation for determining whether a number of generations of the genes and evaluation values of the wiring candidates exceed a certain number in the optimization completion judging step in Step S104. Then, if it is judged that the optimization has been fully achieved in Step S104, the optimization is completed and an optimum wiring candidate is outputted in Step S105.

In a case where it is judged that the optimization is not in progress in the optimization completion judging step in Step S104, the process shifts to a wiring candidate generating step in Step S106 of the genetic algorism to replace genetic codes by altering generations of the genes and to generate wiring candidates, i.e., second wire models, of a next generation.

In the wiring candidate generating step in Step S106 of the genetic algorism, the wiring candidates are generated from end point positions and lengths of the cables specified by the respective genes to alter generations of the genes, i.e., 1G to 2G to 3G . . . in FIG. 17. Still further, the generations are altered by hybridization of genes and spontaneous mutation in the genetic algorism.

For instance, in the examples in FIG. 17, if a gene 1A and a gene 1B of the first generation G1 are selected as parents and are hybridized, a gene 2B having their characteristics is generated. Still further, as for the spontaneous mutation, the gene 2B is selected as a parent, then a gene 3B in which characteristics of the gene 2B has been changed at random is generated. It is possible to improve efficiency by controlling a choice probability of the gene selected as the parent to be proportional with the evaluation values.

A genetic probability of genetic codes of highly evaluated genes is enhanced by searching the wiring candidate, i.e., the wire model, by the arithmetic operation of the genetic algorism as described above. Still further, a eugenic control process affects according to this technique. Therefore, there is a possibility of being able to search a highly optimum wiring candidate, i.e., a wire model, more effectively than a technique of exhaustively searching a large amount of wiring candidates, i.e., wire models, i.e., than a so-called Brute force approach.

As described above, according to the present exemplary embodiment, there is a possibility that the highly optimum wiring design can be obtained in a short time with a calculation resources with limited processing ability by searching the wiring candidates, i.e., the wire models, by the arithmetic operation of the genetic algorism.

The configuration and effects of the exemplary embodiments described above are exemplary to the end, and a person skilled in the art would be able to add design change to the exemplary embodiments described above within a range not departing from the thought of the present disclosure. For instance, the wire model, i.e., the cable model, has been described as having the parameters of the two fixed positions and the length in the exemplary embodiments described above. However, there may be a case where a wire, i.e., a cable, is fixed to a movable unit at a plurality of fixed positions in actual hardware. In such a configuration, an arithmetic operation may be made by allotting a partial wire from one fixed position to another fixed position to the wire model, the cable model, in the exemplary embodiments described above. Still further, while the robot device has been illustrated as the movable unit, a number of joints and disposition of the joints of the robot device are arbitral. The movable unit may be a movable unit driven by some power other than the robot device. Still further, the wire, i.e., the cable, includes a pipe and a tube for transmitting other medium such as air and liquid other than the wire for electrical transmission such as signal cable.

The present disclosure can also be realized by a process that supplies a program that realizes one or more functions of the abovementioned exemplary embodiments to a system or an apparatus through a network or a storage medium, wherein one or more processors within the system or the apparatus read and execute the program. Still further, the present disclosure can be realized by a circuit, e.g., ASIC, that realizes one or more functions.

Still further, while the various exemplary embodiments described above have illustrated the configuration in which the robot device 41 is equipped with the articulate robot arm having a plurality of joints, the number of joints is not limited to that. Still further, while the vertical multi-shaft configuration has been illustrated as the form of the robot device, it is possible to carry out the same configuration with those described above even by joints having different form such as a parallel-link type joints.

The various exemplary embodiments described above are applicable to machines that can automatically perform a telescopic motion, a flexion motion, a vertical move, a lateral move or a swivel motion or their composite motion based on information in the storage unit provided in the control device.

Note that the present disclosure is not limited to the exemplary embodiments described above and may be modified variously within a technical concept of the present disclosure. Still further, the advantageous effects described above in the exemplary embodiments are merely an enumeration of most preferable effects brought about from the present disclosure. That is, the advantageous effects of the present disclosure are not limited to those described in the exemplary embodiments of the present disclosure.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-221557, filed Dec. 6, 2019, which is hereby incorporated by reference herein in its entirety.

What is claimed is:

1. An information processing method comprising:
an output step in which a control device outputs a wire model having a length and a fixed position that satisfy a predetermined condition based on an initial value of at least one fixed position where a wire wired outside of a movable unit is fixed, an initial value of the length of the wire, and search conditions including physical constraints imposed on the wire associated with a move of the movable unit.

2. The information processing method according to claim 1, further comprising:
an initial value setting step in which the control device sets the initial value of the fixed position and the initial value of the length of the wire based on user operation; and
a search condition setting step in which the control device sets the search conditions based on user operation.

3. The information processing method according to claim 1, further comprising:
a first wire model generating step in which the control device generates a first wire model corresponding to the wire based on the initial value of the fixed position and the initial value of the length of the wire; and
a second wire model generating step in which the control device generates at least one second wire model having a length and a fixed position different from those of the first wire model based on the search condition,
wherein the control device outputs the wire model having a length and a fixed position that satisfy the predetermined condition based on the first wire model and/or the second wire model in the output step.

4. The information processing method according to claim 3, further comprising:
an evaluation step in which the control device generates an evaluation value for a length and a fixed position of the first wire model and/or the second wire model based on a result of a simulation that simulates a motion of a device model corresponding to the movable unit and a motion of the first wire model and/or the second wire model associated with the motion of the device model in a virtual environment,
wherein the control device searches based on the evaluation value in the output step.

5. The information processing method according to claim 4, wherein the movable unit is a robot device and the control device simulates a motion of the robot device and a motion of the first wire model and/or the second wire model associated with the motion of the robot device in a virtual environment.

6. The information processing method according to claim 4, wherein the search conditions include a definition of a passable area of the wire model in the virtual environment.

7. The information processing method according to claim 3, wherein the control device generates a length and/or a fixed position of the second wire model based on search ranges of the length and/or the fixed position set by user operation.

8. The information processing method according to claim 3, wherein the physical constraints include a value of a minimum radius of curvature of the second wire model.

9. The information processing method according to claim 3, wherein the physical constraints include a value of a maximum load at an end portion of the second wire model.

10. The information processing method according to claim 1, wherein the control device searches the wire model having the length and the fixed position that satisfy the predetermined conditions by a genetic algorism in the output step.

11. A non-transitory computer-readable recording medium configured to store a control program for executing processes of the information processing method according to claim 1.

12. A control method of a robot device, wherein the movable unit in the information processing method according to claim 1 is a robot device around which the wire is wired, and
wherein the robot device finds a wire model by the information processing method according to claim 1 and controls a motion of the robot device based on the wire model.

13. A robot system comprising the robot device controlled by the control method according to claim 12.

14. An article manufacturing method configured to manufacture articles from workpieces manipulated by the robot system according to claim 13.

15. An information processing apparatus comprising:
a control device that outputs a wire model having a length and a fixed position that satisfy a predetermined condition based on an initial value of at least one fixed position where a wire wired outside of a movable unit is fixed, an initial value of the length of the wire and search conditions including a physical constraint imposed on the wire associated with a motion of the movable unit.

16. The information processing apparatus according to claim 15, wherein the control device generates a first wire model corresponding to the wire based on the initial value of the fixed position and the initial value of the length of the wire,
wherein the control device generates at least one second wire model having a length and a fixed position different from those of the first wire model, and
wherein the control device outputs the wire model having the length and the fixed position that satisfy the predetermined condition based on the first wire model and/or the second wire model.

17. The information processing apparatus according to claim 16, further comprising a user interface unit configured to output a motion of a device model corresponding to the movable unit and a motion of the second wire model associated with the motion of the device model in a virtual environment.

18. The information processing apparatus according to claim 15, further comprising a user interface unit configured to output the wire model having the length and the fixed position that satisfy the predetermined conditions.

19. The information processing apparatus according to claim 15, further comprising a user interface unit that receives user operation for setting the initial value of at least one fixed position where the wire wired outside of the movable unit is fixed and/or the initial value of the length of the wire.

20. The information processing apparatus according to claim 15, further comprising a user interface unit that receives user operation for setting the search conditions including the physical constraints to be satisfied by the wire in association with the motion of the movable unit.

21. The information processing apparatus according to claim 15, further comprising a user interface unit configured to output that there exists no wire model in a case where the wire model that has a length and a fixed position satisfying the predetermined conditions does not exist.
